(19) United States
(12) Patent Application Publication
(10) Pub. No.: US 2024/0278113 A1
(43) Pub. Date: Aug. 22, 2024

(54) DISPLAY IMAGE GENERATION DEVICE AND IMAGE DISPLAY METHOD

(71) Applicant: SONY INTERACTIVE ENTERTAINMENT INC., Tokyo (JP)

(72) Inventors: MITSURU NISHIBE, Chiba (JP); HARUKA IWAKI, Kanagawa (JP); KUNIAKI OE, Tokyo (JP); TAKANORI MINAMINO, Kanagawa (JP)

(21) Appl. No.: 18/426,202

(22) Filed: Jan. 29, 2024

(30) Foreign Application Priority Data
Feb. 16, 2023 (JP) 2023-022465

(51) Int. Cl. A63F 13/26

(52) U.S. Cl. CPC A63F 13/26; A63F 2300/8082

(57) ABSTRACT

Disclosed herein is a display image generation device including a captured image acquiring section that acquires data of an image captured by a camera an intermediate image generating section that generates an intermediate image representing a virtual object arranged in a three-dimensional space for a display object, with the camera as a viewpoint, a display image generating section that generates a composite image representing the intermediate image and the captured image, with a virtual camera for display as a viewpoint, and an output unit that outputs data of the composite image as a display image.

### CROSS REFERENCE TO RELATED APPLICATIONS

This application claims the benefit of Japanese Priority Patent Application JP 2023-022465 filed Feb. 16, 2023, the entire contents of which are incorporated herein by reference.

### BACKGROUND

The present technology relates to a display image generation device for combining a captured image with a computer graphic (CG) to display the combined image, and an image display method.

Image display systems that allow viewing of a target space from a free viewpoint has become widespread. For example, a system has been developed in which a panoramic image is displayed on a head-mounted display, and an image according to a line of sight of a user wearing the head-mounted display is displayed. In a head-mounted display, by displaying stereo images with parallax for a left eye and for a right eye, the displayed image appears three-dimensional to the user, and a sense of immersion in the image world can be enhanced.

In addition, technology has also been put into practical use, which achieves augmented reality (AR) and mixed reality (MR) by installing a camera that capture images of real space on a head-mounted display and combining CGs with the captured images. By displaying the captured image on a closed head-mounted display, the captured image is also useful for the user to check the surroundings or to set a play area for a game.

### SUMMARY

In technologies such as AR and MR that combine computer graphic (CG) with captured images, the accuracy of alignment between the image of a real object and the CG greatly affects quality of content. Furthermore, in the case where a game play area is presented in correspondence with a state of a room in the real world, if there is a discrepancy between the two, the user may be confused and setting of an appropriate play area may be difficult.

On the other hand, in situations where the field of view can change significantly depending on the user's movements, the CG may need to follow the changes, so that a process from acquisition of captured images to generation of a composite image is required to be performed at high speed with less processing load. That is, if calculations take time due to precise positioning in a three-dimensional space, the display will be delayed in response to the user's movements, which will also reduce quality of content and cause motion sickness.

The present technology has been made in view of these problems, and there is desirable to provide a technique for combining CG and captured images with high precision with a small load.

According to an embodiment of the present technology, there is provided a display image generation device. This display image generation device includes a captured image acquiring section that acquires data of an image captured by a camera, an intermediate image generating section that generates an intermediate image representing a virtual object arranged in a three-dimensional space for a display object, with the camera as a viewpoint, a display image generating section that generates a composite image representing the intermediate image and the captured image with a virtual camera for display as a viewpoint, and an output unit that outputs data of the composite image as a display image.

According to another embodiment of the present technology, there is provided an image display method. This image display method includes the steps of acquiring data of an image captured by a camera, generating an intermediate image that represents a virtual object arranged in a three-dimensional space for a display object, with the camera as a view point, generating a composite image representing the intermediate image and the captured image with a virtual camera for display as a viewpoint, and outputting data of the composite image as a display image.

Note that any combination of the above components and the expression of the present technology converted between methods, devices, systems, computer programs, data structures, recording media, etc. are also effective as aspects of the present technology.

According to the present technology, CG and captured images can be combined highly accurately with less load.

### BRIEF DESCRIPTION OF THE DRAWINGS

FIG. 1 is a diagram illustrating an example of appearance of a head-mounted display according to the present embodiment;

FIG. 2 is a diagram illustrating a configuration example of an image display system according to the present embodiment;

FIG. 3 is a diagram schematically illustrating a data path in the image display system according to the present embodiment;

FIG. 4 is a diagram for illustrating a relation between a three-dimensional space that forms the display world of a head-mounted display and a display image generated from a captured image in the present embodiment;

FIG. 5 is a diagram for illustrating a difference from the real world that may occur in a see-through image in the present embodiment;

FIG. 6 is a diagram for illustrating the principle of occurrence of positional deviation when CG is combined with a see-through image in the present embodiment;

FIG. 7 is a diagram for illustrating a method of matching CG with an image of a real object in the present embodiment;

FIG. 8 is a diagram illustrating an internal circuit configuration of a content processing device according to the present embodiment;

FIG. 9 is a diagram illustrating an internal circuit configuration of the head-mounted display according to the present embodiment;

FIG. 10 is a diagram illustrating a configuration of functional blocks of the content processing device according to the present embodiment;

FIG. 11 is a diagram illustrating a virtual object to be displayed in the present embodiment;

FIG. 12 is a diagram illustrating a processing procedure in which the content processing device outputs a composite image and data transition in the present embodiment; and

FIG. 13 is a diagram illustrating another example of the processing procedure in which the content processing device outputs a composite image and data transition in the present embodiment.

### DETAILED DESCRIPTION OF THE PREFERRED EMBODIMENT

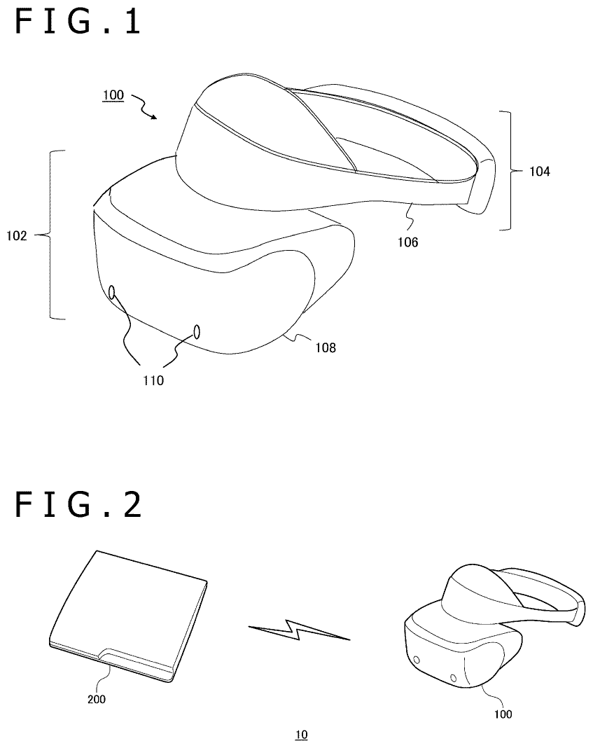

FIG. 1 illustrates an example of appearance of a head-mounted display 100. In this example, a head-mounted display 100 includes an output mechanism section 102 and a mounting mechanism section 104. The mounting mechanism section 104 includes an attachment band 106 that is worn by a user to wrap around a head and secure a device. The output mechanism section 102 includes a housing 108 shaped to cover the right and left eyes when the user is wearing the head-mounted display 100, and has a display panel inside so as to directly face the eyes.

The inside of the housing 108 is further provided with an eyepiece that is positioned between the display panel and the user's eyes when the head-mounted display 100 is worn, and magnifies the image. The head-mounted display 100 may further include speakers or earphones at positions corresponding to the user's ears when worn. Furthermore, the head-mounted display 100 has a built-in motion sensor that detects the translational movement and rotational movement of the head of the user wearing the head-mounted display 100, as well as the position and posture at each time.

The head-mounted display 100 further includes a stereo camera 110 in the front surface of the housing 108, which captures images in a real space from left and right viewpoints. In the present embodiment, a mode is provided in which the real space in a direction in which the user is facing can be seen as it is, by displaying the moving image captured by the stereo camera 110 with a small delay. Hereinafter, such a mode will be referred to as a “see-through mode.” For example, the head-mounted display 100 automatically enters the see-through mode during a period when no content image is displayed.

As a result, the user can check the surrounding situation without removing the head-mounted display 100 before starting, after finishing, or at the time of interrupting the content. In addition, the see-through mode may be started when the user explicitly performs an operation, or may be started or terminated depending on the situation, such as when setting the play area or when the user departs from the play area.

Here, the play area is a range in the real world in which the user viewing the virtual world by using the head-mounted display 100 can move around, such as a range in which safe movement is guaranteed without colliding with surrounding objects. In the illustrated example, the stereo camera 110 is provided at the lower part of the front surface of the housing 108, but its arrangement is not particularly limited. Further, cameras other than the stereo camera 110 may be provided.

Images captured by the stereo camera 110 can also be used as content images. For example, AR and MR can be achieved by displaying a virtual object combined with captured images, in the position, posture, and movement matching with those of a real object in the field of view of the camera. Furthermore, regardless of whether or not the captured image is included in the display, the captured image can be analyzed, and the results can be used to determine the position, posture, and movement of the object to be drawn.

For example, by performing stereo matching on the captured images, corresponding points in the image of the subject may be extracted, and the distance to the subject may be obtained by using the principle of triangulation. Alternatively, the position and orientation of the head-mounted display 100, and thus the position and posture of the user's head relative to the surrounding space may be acquired by using a well-known technique such as visual simultaneous localization and mapping (SLAM). The visual SLAM is a technology in which the three-dimensional position coordinates of feature points on the object surface is acquired on the basis of corresponding points extracted from stereo images, and also the feature points is tracked in frames in chronological order to obtain the position and orientation of the stereo camera 110 and environmental map in parallel.

FIG. 2 illustrates a configuration example of an image display system according to the present embodiment. In an image display system 10, the head-mounted display 100 is connected to a content processing device 200 through wireless communication or an interface for connecting peripheral devices such as a UNIVERSAL SERIAL BUS (USB) Type-C. The content processing device 200 may further be connected to a server via a network. In that case, the server may provide the content processing device 200 with an online application such as a game in which a plurality of users can participate through the network.

The content processing device 200 is basically an information processing device that processes content to generate a display image and transmit the image to the head-mounted display 100 to display it. Typically, the content processing device 200 identifies the position of the viewpoint and the direction of the line of sight on the basis of the position and posture of the head of the user wearing the head-mounted display 100, and generates a display image with the corresponding field of view. For example, the content processing device 200 progresses in an electronic game, generates an image representing a virtual world that is a stage of the game, and accomplishes virtual reality (VR).

In the present embodiment, the content processed by the content processing device 200 is not particularly limited, and may be AR or MR as described above, or may be content for which a display image has been created in advance such as a movie.

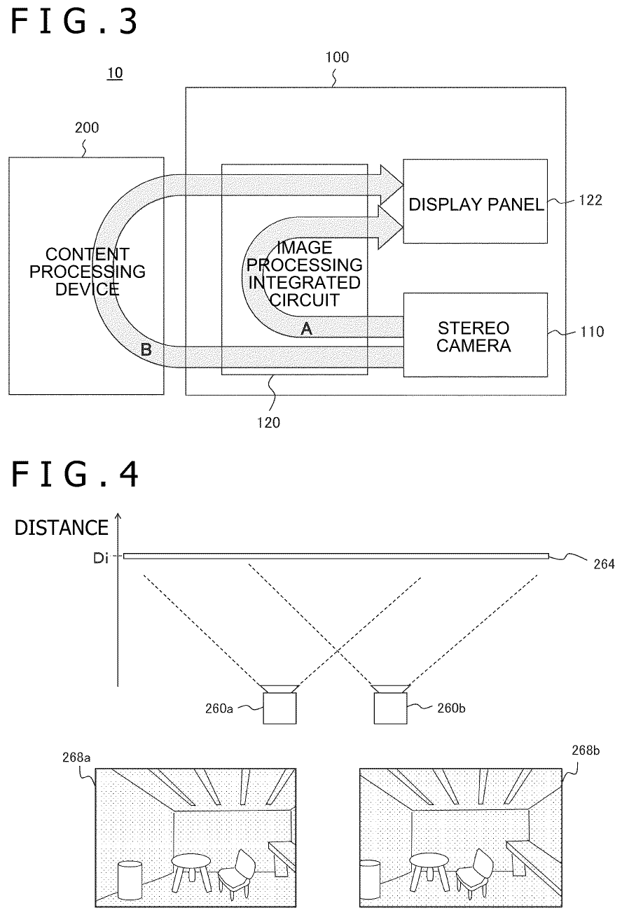

FIG. 3 schematically illustrates a data path in the image display system 10 of the present embodiment. The head-mounted display 100 includes the stereo camera 110 and a display panel 122 as described above. The display panel 122 is a panel having a general display mechanism such as a liquid crystal display or an organic EL display. In the present embodiment, the display panel 122 displays images for the right eye and left eye that constitute a frame of a moving image, in right and left areas directly facing the user's right and left eyes, respectively.

By forming the right-eye image and the left-eye image as stereo images having parallax corresponding to a distance between both eyes, the display object can be made to appear three-dimensionally. The display panel 122 may include two panels in which a panel for the right eye and a panel for the left eye are arranged side by side, or a single panel that displays an image in which the image for the right eye and the image for the left eye are connected horizontally.

The head-mounted display 100 further includes an image processing integrated circuit 120. The image processing integrated circuit 120 is a system-on-chip equipped with various functional modules including a central processing unit (CPU), for example. In addition, the head-mounted display 100 may also include a motion sensor such as a gyro sensor, acceleration sensor, and angular acceleration sensor as described above, a main memory such as a dynamic random-access memory (DRAM), an audio circuit that allows the user to hear audio, and a peripheral device interface circuit for connecting the peripheral devices, which are not illustrated here.

In the figure, two data paths are indicated by arrows in the case where images captured by the stereo camera 110 are included in the display. In the case of implementing AR or MR, generally an image captured by the stereo camera 110 is taken into a main body that processes the content, and is then combined with a virtual object to generate a display image. In the illustrated image display system 10, the main body that processes the content is the content processing device 200, so that as illustrated by an arrow B, the images captured by the stereo camera 110 are sent to the content processing device 200 through the image processing integrated circuit 120.

The images are then combined with a virtual object, for example, and returned to the head-mounted display 100 and displayed on the display panel 122. On the other hand, in the case of the see-through mode, as illustrated by an arrow A, an image captured by the stereo camera 110 can be corrected by the image processing integrated circuit 120 into an image suitable for display, and then displayed on the display panel 122. According to a route of the arrow A, since the data transmission path is much shorter than the route of the arrow B, a time from image capturing to display thereof can be shortened, and a power consumption required for transmission can be reduced.

However, the present embodiment is not intended to limit the data path in the see-through mode to the arrow A. In other words, the route indicated by the arrow B may be adopted, and the images captured by the stereo camera 110 may be once transmitted to the content processing device 200. The image may then be corrected as a display image on the content processing device 200 side and then returned to the head-mounted display 100 to be displayed.

In any case, in the present embodiment, it is preferable to sequentially perform pipeline processing on the images captured by the stereo camera 110 in units smaller than one frame, such as one line at a time, to minimize the time until display. As a result, a possibility is reduced that the user will feel discomfort or motion sickness because the video is displayed with a delay with respect to the movement of the head.

FIG. 4 is a diagram for illustrating a relation between a three-dimensional space that forms the display world of the head-mounted display 100 and a display image generated from a captured image. Note that, in the following description, a captured image converted into a display image will be referred to as a see-through image, regardless of whether it is in the see-through mode or not. The upper part of the figure illustrates a bird's-eye view of a virtual three-dimensional space (hereinafter referred to as a display world) that is constructed when a display image is generated. Virtual cameras 260a and 260b are virtual rendering cameras for generating display images, and correspond to the left and right viewpoints of the user. The upper direction of the diagram represents the depth direction (distance from the virtual cameras 260a, 260b).

See-through images 268a and 268b correspond to images of the interior of the room in front of the head-mounted display 100, which are taken by the stereo camera 110, and illustrate one frame of the left-eye and right-eye display images. Naturally, if the user changes the direction of the user's face, the field of view of the see-through images 268a and 268b will also change. In order to generate the see-through images 268a and 268b, the head-mounted display 100 or the content processing device 200 places a captured image 264 at a predetermined distance Di in the display world, for example.

To be more specific, the head-mounted display 100 displays the captured images 264 from the right and left viewpoints, which are captured by the stereo camera 110, on the inner surface of a sphere with a radius Di centered on the virtual cameras 260a and 260b, respectively, for example. The head-mounted display 100 generates see-through images 268a and 268b for the left eye and right eye by drawing images obtained by viewing the captured images 264 from the virtual cameras 260a and 260b.

Thereby, the captured image 264 captured by the stereo camera 110 is converted into an image seen from the viewpoint of the user viewing the display world. Further, the image of the same subject appears to be slightly shifted rightward in the see-through image 268a for the left eye, and slightly shifted leftward in the see-through image 268b for the right eye. Since images captured from the right and left viewpoints are originally taken with parallax, the images of the subject appear with various amounts of deviation depending on their actual positions (distance) even in the see-through images 268a and 268b. As a result, the user perceives a sense of distance in the image of the subject.

In this way, if the captured image 264 is represented on a uniform virtual surface and the state of the represented image viewed from a viewpoint corresponding to the user is used as the display image, captured images with a sense of depth can be displayed without creating a three-dimensional virtual world in which the arrangement and structure of the subject is accurately traced. Furthermore, if the surface representing the captured image 264 (hereinafter referred to as a projection surface) is a spherical surface that maintains a predetermined distance from the virtual camera 260, the images of objects existing within an assumed range can be expressed with uniform quality regardless of the direction. As a result, both short retardation time and a realistic sensation can be achieved with a small processing load.

On the other hand, when compared with the state obtained by viewing the real world directly, there may be some differences in the image of the real object obtained by the illustrated display method. This difference is difficult to notice when only the see-through image is displayed, but when combined with CG, the difference tends to become apparent as a positional deviation from the CG. CG generally represents a three-dimensional model of a virtual object as seen from the user's viewpoint, whereas a see-through image is originally data obtained separately as a two-dimensional captured image, which may become a factor of this positional deviation. Therefore, in the present embodiment, a composite image with less positional deviation is displayed by drawing CG by assuming the position of the image of the real object in the see-through image.

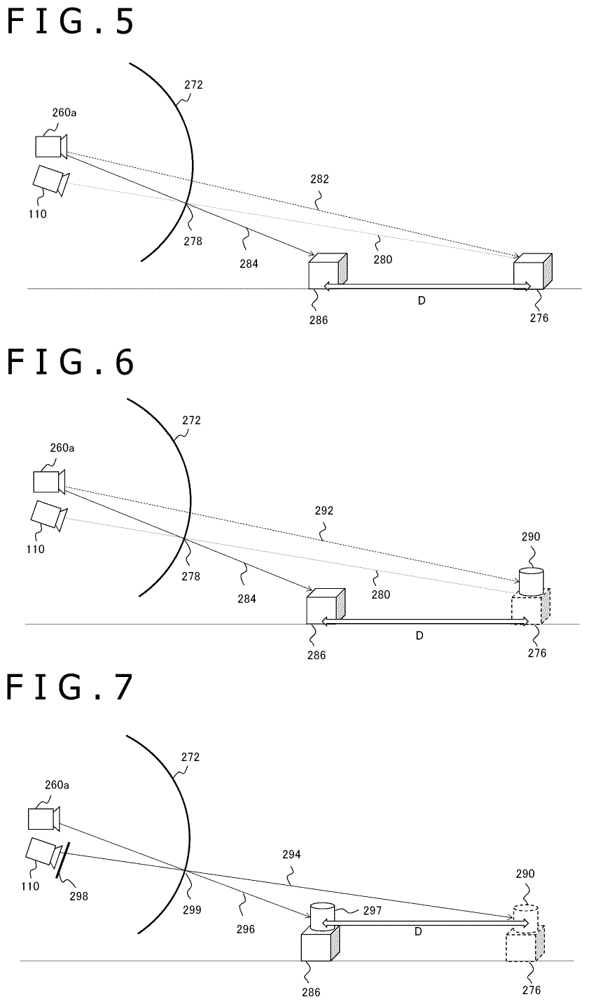

FIG. 5 is a diagram for illustrating the difference between the see-through image and the real world, which may occur in the present embodiment. This figure illustrates a side view of the three-dimensional space of the display world illustrated in the upper part of FIG. 4, and the corresponding camera of the stereo camera 110 is illustrated together with one of the right and left virtual cameras 260a. As described above, the see-through image represents a state obtained by projecting an image captured by the stereo camera 110 onto a projection surface 272 and viewing the projected image from the virtual camera 260a. The projection surface 272 is the inner surface of a sphere with a radius of 2 m centered on the virtual camera 260a, for example. However, the shape and size of the projection surface are not limited to these.

The virtual camera 260a and the stereo camera 110 are linked to the movement of the head-mounted display 100, and thus the user's head. For example, when a rectangular parallelepiped real object 276 enters the field of view of the stereo camera 110, its image is projected, on the projection surface 272, near a position 278 where a sight line 280 from the stereo camera 110 to the real object 276 intersects with the projection surface 272. In the see-through image viewed from the virtual camera 260a, the real object 276, which should originally be in the direction of a sight line 282, is displayed in the direction of a sight line 284. As a result, it appears to the user that the real object 276 stays closer to the user by a distance D (real object 286 on the display).

FIG. 6 is a diagram for illustrating the principle of occurrence of positional deviation when CG is combined with a see-through image. This figure is intended to illustrate how to express a virtual object 290 in CG such that the object exists on the real object 276 in the environment illustrated in FIG. 5. In this case, generally, the three-dimensional position coordinates of the real object 276 are first determined, and the virtual object 290 in the display world is positioned in correspondence therewith.

Then, the state of the virtual object 290 viewed from the virtual camera 260a is drawn as a CG image and the image is combined with the see-through image. According to this procedure, the virtual object 290 on the display is naturally represented as existing in the direction of a sight line 292 from the virtual camera 260a to the virtual object 290. On the other hand, as described with reference to FIG. 5, since the real object 276 is displayed as the real object 286 that is located nearer by the distance D, it appears to the user that the two are out of alignment.

This phenomenon occurs due to the difference in the optical center and optical axis direction between the stereo camera 110 and the virtual camera 260a. In other words, the image of the real object 276 is projected onto the screen coordinate system of the virtual camera 260a via the screen coordinate system corresponding to the imaging plane of the stereo camera 110 and the projection surface 272, whereas the image of the virtual object 290 is directly projected onto the screen coordinate system of the virtual camera 260a, which causes a positional deviation between the two. Therefore, in the present embodiment, a process is incorporated in which the image of the virtual object 290 (CG) is matched with the image of the real object 276 by once projecting the image of the virtual object 290 onto the screen coordinate system of the stereo camera 110 or onto the projection surface 272.

FIG. 7 is a diagram for illustrating a method of matching CG with an image of a real object. In this case, similarly to the case of FIG. 6, the three-dimensional position coordinates of the real object 276 are obtained, and the virtual object 290 is positioned to correspond thereto. On the other hand, in the present embodiment, an intermediate image of the virtual object 290 is generated so as to follow the projection to which the real object 276 is subjected until being represented as a see-through image.

To be specific, by projecting an image of the virtual object 290 onto a screen coordinate system 298 of the stereo camera 110, the state of the virtual object 290 as seen from the stereo camera 110 is represented as an intermediate image. Alternatively, the state obtained by projecting an image of the virtual object 290 viewed from the stereo camera 110 onto the projection surface 272 may be directly represented near a position 299, and may be used as an intermediate image. In any case, according to these intermediate images, the virtual object 290 is represented in the direction of a sight line 294 as seen from the stereo camera 110.

In other words, since the viewpoint of the virtual object is unified with that of the captured image, thereafter, the rest of the processing to generate the see-through image is performed, and if the two are combined at some stage, an image with no misalignment between the CG image and the image of the real object can be displayed. Note that, in this case, the virtual object 290 is represented in the direction of a sight line 296 from the virtual camera 260a. In other words, as in the case of FIG. 5, the virtual object 290 appears to the user to be nearer by a distance D (virtual object 297 on the display), but the positional deviation from the real object 286 in the display is resolved, so that this makes it difficult for the user to notice and it is possible to make it appear as if a highly accurate composite image is being displayed as a whole.

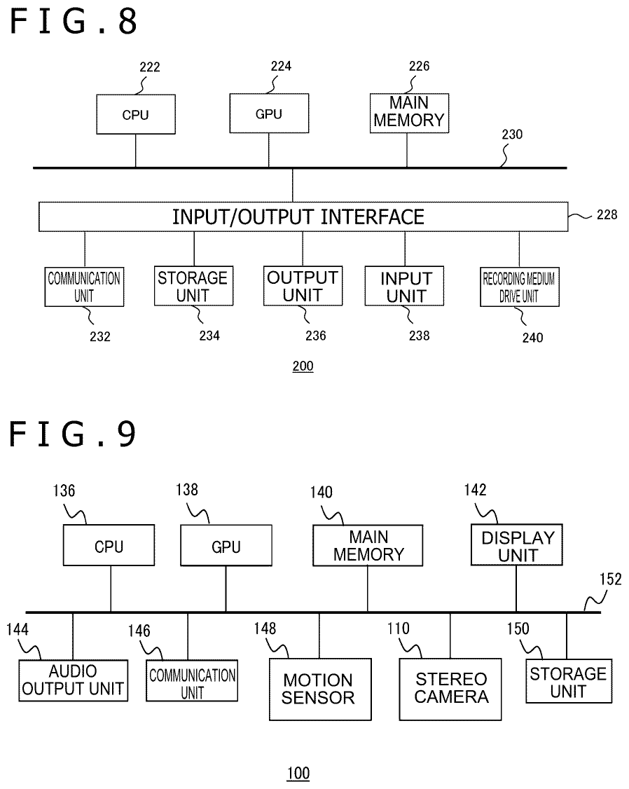

FIG. 8 illustrates the internal circuit configuration of the content processing device 200. The content processing device 200 includes a CPU 222, a graphics processing unit (GPU) 224, and a main memory 226. These units are interconnected via a bus 230. An input/output interface 228 is further connected to the bus 230. A communication unit 232, a storage unit 234, an output unit 236, an input unit 238, and a recording medium drive unit 240 are connected to the input/output interface 228.

The communication unit 232 includes a peripheral device interface such as a USB or Institute of Electrical and Electronics Engineers (IEEE) 1394, and a network interface such as a wired LAN or wireless LAN. The storage unit 234 includes a hard disk drive, nonvolatile memory, and the like. The output unit 236 outputs data to the head-mounted display 100. The input unit 238 accepts data input from the head-mounted display 100, and also accepts data input from a controller (not illustrated). The recording medium drive unit 240 drives a removable recording medium such as a magnetic disk, an optical disk, or a semiconductor memory.

The CPU 222 controls the entire content processing device 200 by executing the operating system stored in the storage unit 234. Further, the CPU 222 executes various programs (e.g., VR game applications, etc.) read from the storage unit 234 or a removable recording medium and loaded into the main memory 226, or downloaded via the communication unit 232. The GPU 224 has the function of a geometry engine and the function of a rendering processor, and performs a drawing process in accordance with a drawing command from the CPU 222, thereby outputting the drawing result to the output unit 236. The main memory 226 includes a RAM and stores programs and data necessary for processing.

FIG. 9 illustrates the internal circuit configuration of the head-mounted display 100. The head-mounted display 100 includes a CPU 136, GPU 138, main memory 140, and display unit 142. These units are interconnected via a bus 152. Further, an audio output unit 144, a communication unit 146, a motion sensor 148, the stereo camera 110, and a storage unit 150 are connected to the bus 152. Note that the configuration of the bus 152 is not limited, and may have a configuration in which a plurality of buses are connected via an interface, for example.

The CPU 136 controls the entire head-mounted display 100 by executing an operating system stored in the storage unit 150. Further, the CPU 136 executes various programs read from the storage unit 150 and loaded into the main memory 140 or downloaded via the communication unit 146. The GPU 138 draws and corrects images in accordance with drawing commands from the CPU 136. The main memory 140 includes a RAM and stores programs and data necessary for processing.

The display unit 142 includes the display panel 122 illustrated in FIG. 3 and displays images in front of the eyes of the user wearing the head-mounted display 100. The audio output unit 144 includes speakers or earphones provided at positions corresponding to the user's ears when the head-mounted display 100 is worn, and allows the user to hear audio.

The communication unit 146 is an interface for transmitting and receiving data with the content processing device 200, and realizes communication by using a known wireless communication technology such as Bluetooth (registered trademark) or a wired communication technology. The motion sensor 148 includes a gyro sensor, an acceleration sensor, an angular acceleration sensor, etc., and acquires the tilt, acceleration, angular velocity, etc. of the head-mounted display 100. As illustrated in FIG. 1, the stereo camera 110 has a pair of video cameras that captures the images of the surrounding real space from right and left viewpoints. The storage unit 150 includes a storage such as a read only memory (ROM).

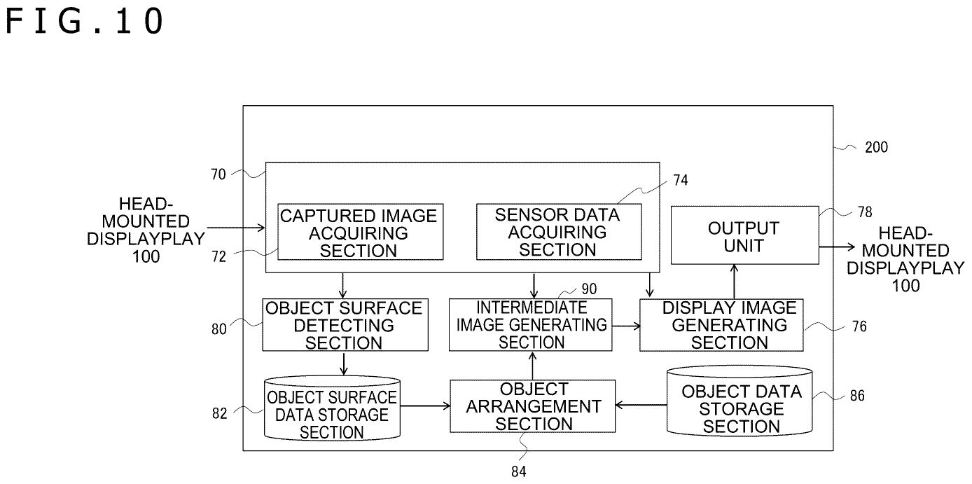

FIG. 10 illustrates the configuration of functional blocks of the content processing device 200 in the present embodiment. The illustrated functional blocks can be achieved with the circuit configuration illustrated in FIG. 8 in terms of hardware, and is achieved by a program that is loaded from the storage unit 234 into the main memory 226 and performs various functions such as a data input function, a data retention function, an image processing function, and a communication function. Therefore, those skilled in the art will understand that these functional blocks can be implemented in various ways using only hardware, only software, or a combination thereof, and are not limited to either one.

Further, the content processing device 200 may have the function of processing various electronic contents and communicating with a server as described above, but the figure illustrates the configuration having a function of combining CG with a see-through image and displaying the image on the head-mounted display 100. From this point of view, the content processing device 200 may be a display image generation device. Note that the head-mounted display 100 may include some of the illustrated functional blocks.

The content processing device 200 includes a data acquisition unit 70 that acquires various data from the head-mounted display 100, a display image generating section 76 that generates display image data, and an output unit 78 that outputs display image data. The content processing device 200 further includes an object surface detecting section 80 that detects the surface of a real object, an object surface data storage section 82 that stores data on the object surface, an object arrangement section 84 that arranges virtual objects in the display world, and an object data storage section 86 that stores data on the virtual objects, and an intermediate image generating section 90 that generates intermediate images of the virtual objects.

The data acquisition unit 70 acquires various data that the head-mounted display 100 continuously acquires, at a predetermined rate. To be specific, the data acquisition unit 70 includes a captured image acquiring section 72 and a sensor data acquiring section 74. The captured image acquiring section 72 acquires data of images captured by the stereo camera 110 from the head-mounted display 100 at a predetermined frame rate.

The sensor data acquiring section 74 acquires data from a motion sensor included in the head-mounted display 100 at a predetermined rate. The sensor data may be measured values such as acceleration or angular acceleration, or may be data on the translational movement or rotational movement of the head-mounted display 100, or the position and orientation at each time, which are derived by using the measured values. In the former case, the sensor data acquiring section 74 derives the position and orientation of the head-mounted display 100 at a predetermined rate by using the acquired measured values.

The object surface detecting section 80 detects the surfaces of real objects around the user in the real world. For example, the object surface detecting section 80 generates the data of an environmental map that represents the distribution of feature points on the object surface in a three-dimensional space. In this case, the object surface detecting section 80 sequentially acquires data of captured images from the captured image acquiring section 72 and executes the above-mentioned visual simultaneous localization and mapping (SLAM) to generate environmental map data. However, the detection method performed by the object surface detecting section 80 and the expression format of the detection results are not particularly limited. The object surface data storage section 82 stores data indicating the detection results by the object surface detecting section 80, such as data of an environmental map.

The object data storage section 86 stores arrangement rules for virtual objects to be combined with the see-through image and data on a three-dimensional model to be represented in CG. The object arrangement section 84 arranges virtual objects in the three-dimensional space of the display world on the basis of the information stored in the object data storage section 86. In the case where a virtual object is represented in accordance with the position and movement of a real object as illustrated in FIG. 7, the object arrangement section 84 acquires three-dimensional position information of the object surface such as an environmental map from the object surface data storage section 82, and determines the three-dimensional position and posture of the virtual object in accordance therewith.

The intermediate image generating section 90 generates an intermediate image obtained by aligning the viewpoint for the virtual object arranged in the three-dimensional display world with the viewpoint for the real object represented in the captured image. The display image generating section 76 uses the intermediate image and the captured image to generate a display image in which CG is combined with the see-through image. There are the following two steps for generating a display image through cooperation between the intermediate image generating section 90 and the display image generating section 76, for example.

### (Step 1)

The intermediate image generating section 90 generates an intermediate image in which CG is drawn in the screen coordinate system of the stereo camera 110. As a result, since the viewpoint for the captured image and the viewpoint for the virtual object are already aligned, the display image generating section 76 can generate an image with no misalignment between the CG image and the image of the real object by combining those. Then, as in the case of generating a see-through image, the display image generating section 76 projects the composite image onto a projection surface (for example, the projection surface 272 in FIG. 7) and generates a display image by representing the state seen from the virtual camera 260.

### (Step 2)

The intermediate image generating section 90 draws (projects) an image of the virtual object seen from the stereo camera 110, as an intermediate image, onto a projection surface (for example, the projection surface 272 in FIG. 7) on which the captured image is projected when generating the see-through image. That is, the intermediate image generating section 90 draws CG in the same state as the captured image projected onto the projection surface 272. In this case, the display image generating section 76 generates an image of the state obtained by viewing the intermediate image from the virtual camera 260 and an image of the state obtained by viewing the captured image projected onto the projection surface 272 from the virtual camera 260, and combines both to create a display image.

There is a difference between step 1 and step 2 as to whether the compositing process is performed before or after projection onto the projection surface. In the case of step 1, by combining CG with the captured image in accordance with the viewpoint of the stereo camera 110, the subsequent processing is similar to the process of generating a see-through image from the captured image. In this case, by drawing and combining CG first in accordance with the viewpoint of the stereo camera 110, a natural display image can be ultimately generated regardless of the density of polygons.

In the case of step 2, processing similar to that for generating a see-through image from a captured image is performed separately for CG and the captured image, and then the two are combined. Note that drawing of CG on the projection surface can be performed by well-known projective transformation without a step of drawing on the screen coordinate system of the stereo camera 110. In other words, since the CG as seen from the virtual camera 260 can be directly drawn in this case, speed-up of processing can be expected.

Either procedure can eventually generate a display image in which there is no misalignment between the captured image of the real object and the CG. The viewpoint position and sight line direction of the stereo camera 110, the position and orientation of the projection surface, and the position and orientation of the virtual camera 260, which are used when the intermediate image generating section 90 and the display image generating section 76 generate their respective images, depend on the movement of the head-mounted display 100, and eventually the user's head. Therefore, the intermediate image generating section 90 and the display image generating section 76 determine these parameters at a predetermined rate on the basis of the data acquired by the data acquisition unit 70.

Note that, in either procedure, the intermediate image generating section 90 is not limited to actually drawing CG as an intermediate image, and may only generate information that determines the position and orientation of the image. For example, the intermediate image generating section 90 may represent only the vertex information of CG on an image plane as an intermediate image. Here, the vertex information may be data used for general CG drawing, such as position coordinates, normal vectors, colors, and texture coordinates. In this case, the display image generating section 76 may draw the actual CG while appropriately converting the viewpoint on the basis of the intermediate image at the stage of combining the CG with the see-through image, for example. This reduces the load required to generate intermediate images and allows faster generation of composite images.

The output unit 78 acquires display image data from the display image generating section 76, and performs processing necessary for display, thereby sequentially outputting the data to the head-mounted display 100. The display image includes a pair of images for the left eye and for the right eye. The output unit 78 may correct the displayed image in a direction that cancels out distortion and chromatic aberration, so that a distortion-free image is visually recognized when viewed through the eyepiece. In addition, the output unit 78 may perform various data conversions corresponding to the display panel of the head-mounted display 100.

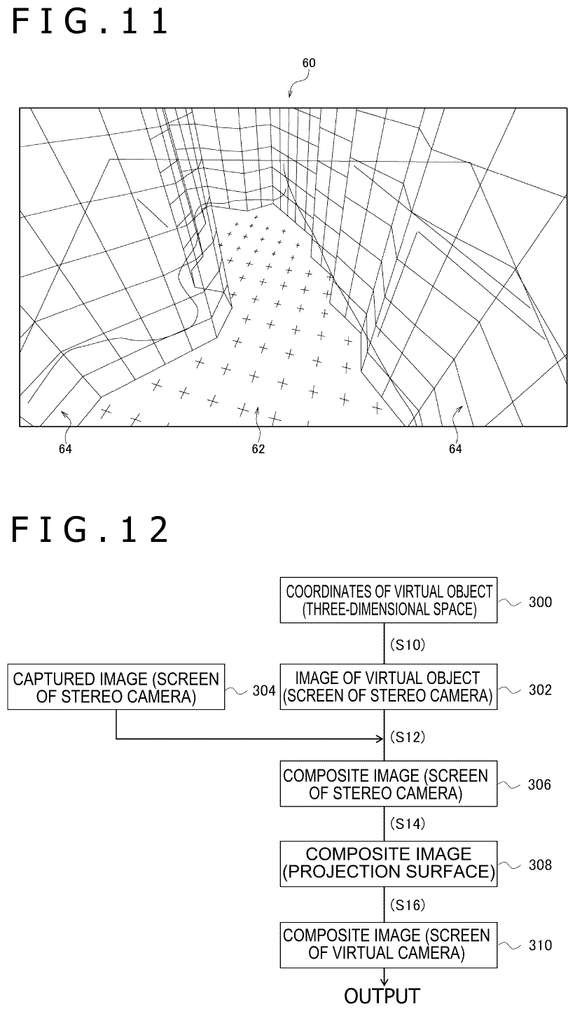

FIG. 11 illustrates virtual objects to be displayed in the present embodiment. In this example, as the virtual object, a play area object that is displayed when the user sets the play area is illustrated. A play area object 60 includes a floor portion 62 and a boundary surface portion 64. The floor portion 62 represents the range of the play area on the floor. The boundary surface portion 64 represents the boundary surface of the play area, and includes, for example, a surface that intersects perpendicularly to the floor. The floor portion 62 and the boundary surface portion 64 are represented, for example, as translucent grid-shaped objects.

For example, the object arrangement section 84 identifies the position and size of the floor on the basis of the data representing the structure of the surface of objects around the user, detected by the object surface detecting section 80, and then determines the position and shape of the play area in the three-dimensional display world in accordance with these. The image of the play area determined in this way is combined with a see-through image and displayed, so that the user can easily grasp the range of the play area in the real world and adjust the play area as appropriate.

However, for the reasons mentioned above, if the image of the play area is misaligned with the image of the real object on the display image, the floor portion 62 represented by CG may appear to be separated from the image of the actual floor, for example, and this may interfere with understanding and adjusting the play area. According to step 1 or step 2 described above, such problems are less likely to occur.

FIG. 12 illustrates a processing step in which the content processing device 200 outputs a composite image and the transition of data. The figure is prepared for the above step 1. First, the object arrangement section 84 of the content processing device 200 places a three-dimensional model of a virtual object in the three-dimensional space of the display world as necessary for setting a play area, performing AR and MR, and the like. At this time, the object arrangement section 84 determines the three-dimensional coordinates 300 of the virtual object at the corresponding position on the basis of the three-dimensional coordinates of the real object, stored in the object surface data storage section 82.

Next, the intermediate image generating section 90 draws an image 302 of the virtual object, namely CG, in the screen coordinate system of the stereo camera 110 as an intermediate image (S10). On the other hand, the display image generating section 76 acquires data on an image 304 captured by the stereo camera 110 from the captured image acquiring section 72. This captured image 304 naturally represents a state obtained by projecting the image of a real object onto the screen coordinate system of the stereo camera 110.

The display image generating section 76 combines the image 302 of the virtual object with the captured image 304 to generate a composite image 306 in the screen coordinate system of the stereo camera (S12). Since the composite image represents how the virtual object and the real object are viewed from the same stereo camera 110, no positional deviation occurs between the two. Subsequently, the display image generating section 76 generates a composite image 308 obtained by projecting the composite image 306 onto a predetermined projection surface (S14).

Then, the display image generating section 76 draws a composite image 310 obtained by projecting the composite image 308 on the projection surface onto the screen coordinate system of the virtual camera for display, that is, the display image plane (S16). The display image generating section 76 outputs the composite image 310 to the output unit 78 as a display image. As described above, the output unit 78 performs correction to give distortion according to the eyepiece provided in the head-mounted display 100, or other corrections on the displayed image, and then outputs the image to the head-mounted display 100.

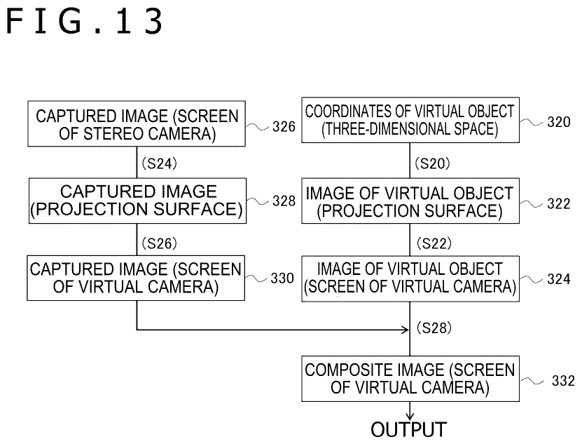

FIG. 13 illustrates another example of the processing procedure in which the content processing device 200 outputs a composite image, and data transition. The figure is prepared for the above step 2. First, the object arrangement section 84 of the content processing device 200 determines three-dimensional coordinates 320 of the virtual object at the corresponding position on the basis of the three-dimensional coordinates of the real object, as in the example of FIG. 12. Next, the intermediate image generating section 90 draws an image 322 of the virtual object, namely CG, representing a state obtained by projecting an image of the virtual object onto a predetermined projection surface, as an intermediate image (S20).

At this time, as described in FIG. 7, the intermediate image generating section 90 projects the image of the virtual object 290 seen from the stereo camera 110 onto the projection surface 272 so as to substantially perform alignment with the captured image projected onto the same projection surface 272. The display image generating section 76 draws an image 324 of the virtual object obtained by projecting the image 322 of the virtual object on the projection surface onto the screen coordinate system of the virtual camera for display, that is, the display image plane (S22).

On the other hand, the display image generating section 76 acquires a captured image 326 taken by the stereo camera 110 from the captured image acquiring section 72, and generates a captured image 328 obtained by projecting the captured image onto a predetermined projection surface (S24). The display image generating section 76 then draws a captured image 330 obtained by projecting the captured image 328 on the projection surface onto the screen coordinate system of the virtual camera for display (S26). The display image generating section 76 then combines the image 324 of the virtual object with the captured image 330, and generates a composite image 332 in the screen coordinate system of the virtual camera (S28).

Note that the process in S26 of drawing the captured image 330 in the screen coordinate system of the virtual camera can be actually done together with the compositing process in S28 by directly drawing the captured image on the image plane on which the image 324 of the virtual object is represented. The display image generating section 76 outputs the composite image 332 to the output unit 78 as a display image. In this case as well, the output unit 78 performs appropriate correction on the display image and outputs the image to the head-mounted display 100.

According to the present embodiment described above, when an image captured by a camera provided in a head-mounted display and CG of a three-dimensional virtual object are combined with each other and displayed, an intermediate image representing the CG from the camera viewpoint is first generated, and then a composite image from a viewpoint for display is generated. As a result, a composite image with no misalignment between the CG and the image of the real object can be generated, without a step of heavy-load processing such as strictly associating the captured image with the three-dimensional real space structure. As a result, highly accurate composite images can continue to be displayed at high speed regardless of the user's movements.

The present technology has been described above based on the embodiments. Those skilled in the art will understand that the embodiments are illustrative, and that various modifications can be made to the combinations of their components and processing steps, and that such modifications are also within the scope of the present technology.

For example, the object to be combined with CG is not limited to images taken by a stereo camera included in a head-mounted display. For example, even if the image is captured by a monocular camera or three or more compound-eye camera, a composite image without misalignment between the captured image and CG can be generated with a low processing load by processing similar to the present embodiment. Further, the display device is not limited to a head-mounted display, and can be applied as long as the display system has different viewpoints for a captured image and a displayed image.

What is claimed is:

1. A display image generation device comprising:
a captured image acquiring section that acquires data of an image captured by a camera;
an intermediate image generating section that generates an intermediate image representing a virtual object arranged in a three-dimensional space for a display object, with the camera as a viewpoint;
a display image generating section that generates a composite image representing the intermediate image and the captured image, with a virtual camera for display as a viewpoint; and
an output unit that outputs data of the composite image as a display image.

2. The display image generation device according to claim 1, wherein
the captured image acquiring section acquires the image captured by the camera included in a head-mounted display, and
the output unit outputs the data of the composite image to the head-mounted display.

3. The display image generation device according to claim 1, wherein
the intermediate image generating section generates the intermediate image representing a state obtained by projecting an image of the virtual object onto a screen coordinate system of the camera, and
the display image generating section generates the composite image by combining the captured image with the intermediate image in the screen coordinate system of the camera, and converting the combined image into an image with the virtual camera as a viewpoint.

4. The display image generation device according to claim 3, wherein
the display image generating section projects the image combined in the screen coordinate system of the camera onto a projection surface set in the three-dimensional space, and uses an image obtained by viewing the projected combined image from the virtual camera as the composite image.

5. The display image generation device according to claim 1, wherein
the intermediate image generating section generates the intermediate image representing a state obtained by projecting the image of the virtual object seen from the camera onto a projection surface set in the three-dimensional space, and
the display image generating section generates the composite image by combining an image obtained by viewing the intermediate image from the virtual camera with an image obtained by viewing the captured image projected onto the projection surface from the virtual camera.

6. The display image generation device according to claim 1, wherein
the intermediate image generating section generates the intermediate image representing vertex information of the virtual object, and
the display image generating section draws an image of the virtual object in the composite image by using the vertex information.

7. A method for displaying an image comprising:
acquiring data of an image captured by a camera;
generating an intermediate image representing a virtual object arranged in a three-dimensional space for a display object, with the camera as a viewpoint;
generating a composite image representing the intermediate image and the captured image, with a virtual camera for display as a viewpoint; and
outputting data of the composite image as a display image.

8. A program for a computer, comprising:
by a captured image acquiring section, acquiring data of an image captured by a camera;
by an intermediate image generating section, generating an intermediate image representing a virtual object arranged in a three-dimensional space for a display object, with the camera as a viewpoint;
by a display image generating section, generating a composite image representing the intermediate image and the captured image, with a virtual camera for display as a viewpoint; and
by an output unit, outputting data of the composite image as a display image.
